(19) United States
(12) Patent Application Publication
(10) Pub. No.: US 2009/0173891 A1
(43) Pub. Date: Jul. 9, 2009

(54) FLUORESCENCE DETECTION SYSTEM

(75) Inventor: Ryutaro ODA, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 12/343,121

(22) Filed: Dec. 23, 2008

(30) Foreign Application Priority Data
Jan. 7, 2008 (JP) 2008-000751

(51) Int. Cl. G01J 1/58

(52) U.S. Cl. 250/483.1

(57) ABSTRACT

A fluorescence detection system in which at least one of a plurality of light-receiving elements arranged on the light-receiving surface of a photodetector serves as a excitation-light detection section for receiving a light component having a wavelength of the excitation light, and at least one of the remaining light-receiving elements serves as a fluorescence detection section for receiving a light component having a wavelength of the fluorescence. A fluorescence-intensity correction section is operable to perform a calculation of dividing a detection signal from the fluorescence detection section by a detection signal from the excitation-light detection section, and output the calculated value as a measurement value.

### BACKGROUND OF THE INVENTION

1. Field of the Invention

The present invention relates to a fluorescence detection system designed to irradiate a sample with excitation light and measure fluorescence generated from the sample. The fluorescence detection system is used with a liquid chromatograph, etc., or as an independent spectral fluorescence detector.

2. Description of the Background Art

FIG. 6 schematically shows a configuration of a conventional fluorescence detection system.

A typical fluorescence detection system is equipped with a first optical system for spectrally dispersing light from a light source 2 composed of a discharge lamp, such as a xenon lamp, and converging a light component which corresponds to a wavelength absorbable by a sample and serves as excitation light, onto a sample cell 10, and a second optical system for converging light from the sample and leading a given component of the converged light to a photodetector 48, such as a photomultiplier.

The first optical system for irradiating a sample with excitation light comprises: an excitation-side wavelength selection means 6 for extracting only a light component conforming to a wavelength absorbable by the sample, as excitation light, which is composed of a spectroscope (i.e., spectral dispersion device) using a diffraction grating, or a filter such as an interference filter; a pair of lenses 4a, 4b for converging light from the light source 2 onto the excitation-side wavelength selection means 6; and a pair of lenses 8a, 8b for converging the excitation light from the excitation-side wavelength selection means 6 onto the sample set in the sample cell 10.

The second optical system for leading light from the sample to the photodetector 48 comprises a fluorescence-side wavelength selection means 46 for selectively leading a light component having a wavelength of fluorescence to the photodetector 48, and a pair of lenses 44a, 44b for converging light from the sample onto the fluorescence-side wavelength selection means 46.

An intensity of fluorescence generated from a sample is proportional to an intensity of excitation light irradiating the sample. If an intensity of the light source 2 fluctuates, the intensity of the excitation light will fluctuate to cause a fluctuation in intensity of the fluorescence generated from the sample. Thus, the fluctuation in intensity of the light source gives rise to noise in fluorescence measurements.

With a view to reducing an influence of noise due to a fluctuation in intensity of the light source 2, the following technique has been employed. A part of excitation light is split, for example, using a beam splitter 50 disposed between the excitation-side wavelength selection means 6 and the sample, in such a manner that the split light is led to a photodetector 52 provided separately from the photodetector 48 for detecting fluorescence, as also shown in FIG. 6. Then, a calculation is performed to divide an intensity of fluorescence detected in the photodetector 48 by an intensity of excitation light detected in the photodetector 52, and the calculated value is output as a measurement value. This type of fluorescence detection system is disclosed, for example, in JP 8-136523A.

The following alternative technique has also been employed. As shown in FIG. 7, the photodetector 52 is disposed on one side of the sample cell 10 opposite to a position where excitation light enters into the sample cell 10, to detect an intensity of excitation light transmitted through the sample cell 10. Then, a calculation is performed to divide an intensity of fluorescence detected in the photodetector 48 by the intensity of the excitation light detected in the photodetector 52, and the calculated value is output as a measurement value.

Fluorescence is generated from a position where a sample set in a sample cell is irradiated with excitation light. However, in a small-size sample cell, such as a sample cell for use in a fluorescence detection system for a liquid chromatograph, light output from an excitation-side spectroscope is likely to be partially blocked by an aperture or a cell. In this case, an intensity of excitation light detected in order to correct a fluctuation in intensity of a light source as described above is not fully identical to an intensity of excitation light actually exciting the sample. Consequently, a fluctuation in intensity of fluorescence generated from the sample due to a fluctuation in intensity of excitation light caused by a fluctuation in intensity of the light source cannot be fully corrected, and thereby noise arising from the fluctuation in intensity of the light source will be undesirably included in an output of a fluorescence detection system. The output of the fluorescence detection system including noise arising from the fluctuation in intensity of the light source causes a problem about deterioration in measurement accuracy and incapability of high-sensitive detection.

### SUMMARY OF THE INVENTION

It is therefore an object of the present invention to provide a fluorescence detection system capable of accurately correcting an error arising from a fluctuation in intensity of excitation light irradiating a sample.

In order to achieve this object, the present invention provides a fluorescence detection system which comprises: a light source; a sample cell; a first optical system for irradiating a sample set in the sample cell, with excitation light based on light from the light source; a fluorescence detection section for detecting fluorescence generated from the sample; a second optical system for selectively leading the fluorescence from the sample to the fluorescence detection section; an excitation-light detection section for detecting scattered light from the sample cell; a third optical system for leading scattered light from a same position as a fluorescence measurement position of the sample set in the sample cell, to the excitation-light detection section; and a fluorescence-intensity correction section for correcting a detection value of the fluorescence detection section by a detection value of the excitation-light detection section.

In one preferred embodiment of the present invention, the second optical system and the third optical system share a common spectral dispersion element, and each of the fluorescence detection section and the excitation-light detection section is formed as an array-type photodetector having an array of light-receiving elements arranged in a spectral dispersion direction of the spectral dispersion element, wherein the fluorescence detection section is made up of at least one of the light-receiving elements disposed at a position capable of receiving a light component having a wavelength of the fluorescence among light components spectrally dispersed by the spectral dispersion element, and the excitation-light detection section is made up of at least one of the remaining light-receiving elements disposed at a position capable of receiving a light component having a wavelength of the excitation light among the light components spectrally dispersed by the spectral dispersion element.

In another preferred embodiment of the present invention, the second optical system and the third optical system share a common dichroic mirror configured to reflect one of a first group of light components having a wavelength band including a wavelength of the fluorescence and a second group of light components having a wavelength band including a wavelength of the scattered light corresponding to the excitation light, and transmit the other of the first and second group therethrough, in such a manner as to allow the first group and the second group in light which have undergone said dichroic mirror, to be detected by the fluorescence detection section and the excitation-light detection section, respectively.

In yet another preferred embodiment of the present invention, the second optical system and the third optical system are axisymmetrically arranged with respect to a symmetry axis defined by an optical axis of the excitation light entering from the first optical system into the sample cell, wherein the fluorescence detection section is disposed at a position capable of receiving light output from the second optical system, and the excitation-light detection section is disposed at a position capable of receiving light output from the third optical system.

In this embodiment, the third optical system preferably includes a spectral dispersion element operable to select a light component having a wavelength of the excitation light, and lead the selected light component to the excitation-light detection section. According to this feature, a component of the fluorescence generated from the sample can be removed from light to be led to the excitation-light detection section. This makes it possible to eliminate an error which otherwise occurs due to the fluorescence component included in light detected by the excitation-light detection section.

In still another preferred embodiment of the present invention, the second optical system and the third optical system share common beam-splitting means operable to reflect a part of light beam from the sample cell, and transmit the remainder therethrough, in such a manner as to allow the two light beams split by the beam-splitting means to be detected by the excitation-light detection section and the fluorescence detection section, respectively.

In this embodiment, the third optical system preferably includes a spectral dispersion element operable to select a light component having a wavelength of the excitation light, and lead the selected light component to the excitation-light detection section. According to this feature, a component of the fluorescence generated from the sample can be removed from light to be led to the excitation-light detection section. This makes it possible to eliminate an error which otherwise occurs due to the fluorescence component included in light detected by the excitation-light detection section.

As above, the fluorescence detection system of the present invention comprises the fluorescence detection section for detecting fluorescence generated from the sample, and further the excitation-light detection section for detecting scattered light from the fluorescence measurement position of the sample set in the sample cell, wherein a calculation is performed to divide an intensity of the fluorescence detected in the fluorescence detection section by an intensity of the scattered light detected in the excitation-light detection section, and the calculated value is output as a measurement value. Thus, a fluctuation in intensity of the excitation light irradiating the sample cell at a position for generating fluorescence can be figured out with accuracy to accurately correct an intensity of the fluorescence from the sample in response to the fluctuation. Specifically, an intensity of the scattered light from the sample set in the sample cell corresponds to the fluctuation in intensity of the excitation light irradiating the sample, therefore an output value free from an influence of the fluctuation in intensity of the excitation light irradiating the sample can be obtained through an operation of detecting the intensity of the scattered light, performing a calculation of dividing the intensity of the fluorescence from the sample by the detected intensity of the scattered light, and outputting the calculated value. This makes it possible to perform high-sensitive measurements low in noise due to the fluctuation in intensity of the excitation light irradiating the sample.

### BRIEF DESCRIPTION OF THE DRAWINGS

FIG. 1 is a block diagram schematically showing a configuration of a fluorescence detection system according to a first embodiment of the present invention.

FIG. 2 is a block diagram schematically showing a configuration of a fluorescence detection system according to a second embodiment of the present invention.

FIG. 3 is a block diagram schematically showing a configuration of a fluorescence detection system according to a third embodiment of the present invention.

FIG. 4 is a block diagram schematically showing a configuration of a fluorescence detection system according to a fourth embodiment of the present invention.

FIG. 5 is a block diagram showing one example where excitation-side wavelength selection means is incorporated in the fluorescence detection system according to the fourth embodiment.

FIG. 6 is a block diagram schematically showing one example of a configuration of a conventional fluorescence detection system.

FIG. 7 is a block diagram schematically showing another example of the configuration of the conventional fluorescence detection system.

### DESCRIPTION OF THE EXEMPLARY EMBODIMENTS

With reference to the drawings, the present invention will now be specifically described based on an exemplary embodiment thereof.

### First Embodiment

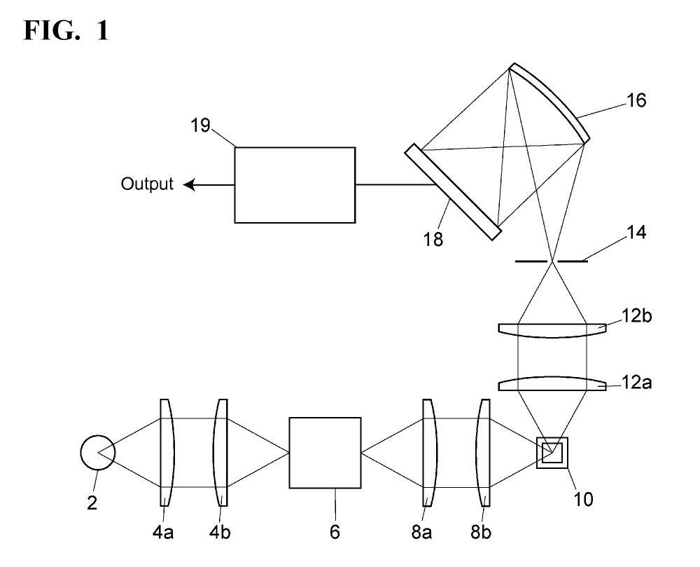

FIG. 1 is a block diagram schematically showing a configuration of a fluorescence detection system according to a first embodiment of the present invention.

For example, when the present invention is applied to a fluorescence detection system for a liquid chromatography, a sample cell 10 in FIG. 1 is a flow cell. It is understood that the sample cell 10 may be a cell for an independent spectral fluorescence detector.

The fluorescence detection system according to the first embodiment is designed such that a sample set in the sample cell 10 is irradiated with light emitted from a light source lamp 2, and resulting light generated from the sample is led to and detected by a photodetector 18.

A first optical system is provided between the light source lamp 2 and the sample cell 10, to irradiate the sample set in the sample cell 10, with excitation light, while spectrally dispersing light from the light source lamp 2, and selectively extracting a light component having a wavelength absorbable by the sample, as the excitation light. The first optical system comprises: a pair of lenses 4a, 4b for converging light from the light source lamp 2; an excitation-side wavelength selection means 6 for spectrally dispersing the light converged by the lenses 4a, 4b, and selectively extracting therefrom a light component having a wavelength absorbable by the sample, as excitation light, which is composed of a spectroscope using a diffraction grating, or a filter such as an interference filter; and a pair of lenses 8a, 8b for converging the excitation light from the excitation-side wavelength selection means 6 onto the sample cell 10.

A second optical system is provided between the sample cell 10 and the photodetector 18, to converge fluorescence and scattered light from the sample set in the sample cell 10, and lead the converged light to the photodetector 18 in such a manner as to be spectrally dispersed as a function of wavelength. The second optical system comprises a pair of lenses 12a, 12b for converging light from the sample in the sample cell 10, a slit 14 for leading the light converged by the lenses 12a, 12b to a diffraction grating 16 for spectrally dispersing incident light as a function of wavelength.

The photodetector 18 is composed of an array of light-receiving elements, such as a photodiode array. In the photodiode 10, at least one of the light-receiving elements disposed at a position capable of receiving a light component having a wavelength of the fluorescence among light components spectrally dispersed by the refraction grating 16 makes up a fluorescence detection section, and at least one of the remaining light-receiving elements disposed at a position capable of receiving a light component having a wavelength of the scattered light corresponding to the excitation light among light components spectrally dispersed by the refraction grating 16 makes up an excitation-light detection section. As above, in the first embodiment, at least one of the light-receiving elements arranged on a light-receiving surface of the photodetector 18 is associated with a light component having a wavelength of the excitation light to serve as the excitation-light detection section, and at least one of the remaining light-receiving elements is associated with a light component having a wavelength of the fluorescence to serve as the fluorescence detection section. That is, a combination of the pair of lenses 12a, 12b, the slit 14 and the diffraction grating 16 also makes up a third optical system for leading scattered light from the same position as a fluorescence measurement position of the sample set in the sample cell 10, to the excitation-light detection section.

The reference numeral 19 indicates a fluorescence-intensity correction section for correcting a signal from the fluorescence detection section of the photodetector 18 by a signal from the excitation-light detection section of the photodetector 18. Specifically, the fluorescence-intensity correction section 19 is operable to perform a calculation of dividing a signal from the light-receiving element of the fluorescence detection section of the photodetector 18 by a signal from the light-receiving element of the excitation-light detection section of the photodetector 18, and output the calculated value as a measurement value, i.e., a measured intensity of the fluorescence. Due to a fluctuation in intensity of the excitation light irradiating the sample set in the sample cell 10, each of the fluorescence and scattered light from the sample fluctuates in the same manner. Thus, a measurement value less affected by the fluctuation in intensity of the excitation light irradiating the sample can be obtained by performing a calculation of dividing the detected intensity of the fluorescence by the detected intensity of the scattered light, and outputting the calculated value as the measurement value.

An operation of the fluorescence detection system according to the first embodiment will be described below.

Light emitted from the light source lamp 2 is converged by the lenses 4a, 4b, and led to the excitation-side wavelength selection means 6. Excitation light output from the excitation-side wavelength selection means 6 is converged by the lenses 8a, 8b to irradiate the sample in the sample cell 10. Light including fluorescence and scattered light generated in the sample cell 10 is converged by the lenses 12a, 12b, and led to the diffraction grating 16 via the slit 14. Then, light components spectrally dispersed by the diffraction grating 16 are projected onto the light-receiving surface of the photodetector 18, individually. The fluorescence-intensity correction section 19 performs a calculation of dividing a signal from the light-receiving element serving as the fluorescence detection section of the photodetector 18 by a signal from the light-receiving element serving as the excitation-light detection section of the photodetector 18, and outputs the calculated value as a measurement value.

### Second Embodiment

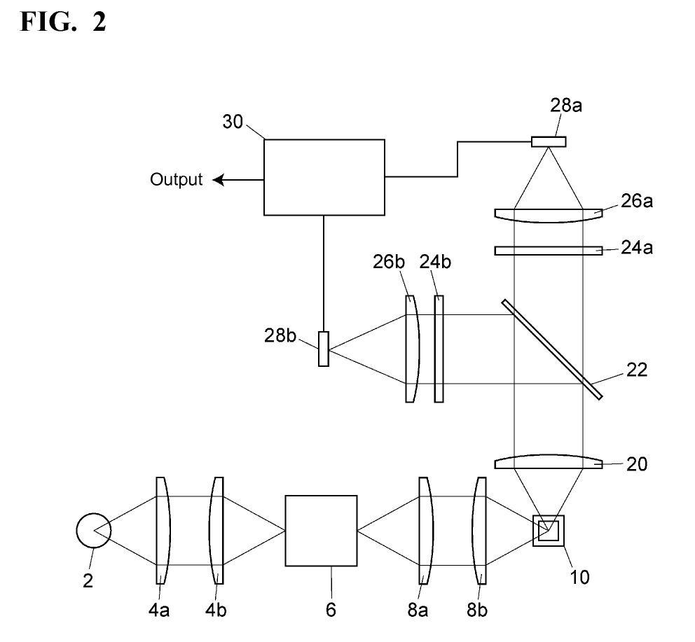

FIG. 2 is a block diagram schematically showing a configuration of a fluorescence detection system according to a second embodiment of the present invention.

The fluorescence detection system according to the second embodiment is designed such that light from a sample is split into a first group of light components including fluorescence and a second group of light components including scattered light, using a dichroic mirror 22, and the first and second groups are detected by independent first and second photodetectors 28a, 28b, respectively. A photomultiplier or a photodiode may be used as each of the first and second photodetectors 28a, 28b. Although the first photodetector 28a and the second photodetector 28a in the second embodiment are designed to serve, respectively, as an excitation-light detection section and a fluorescence detection section, the present invention is not limited to this configuration, but the first photodetector 28a and the second photodetector 28a in the second embodiment may be designed to serve, respectively, as the fluorescence detection section and the excitation-light detection section.

A first optical system is provided between a light source lamp 2 and a sample cell 10, to irradiate a sample set in the sample cell 10, with excitation light, while spectrally dispersing light from the light source lamp 2, and selectively extracting a light component having a wavelength absorbable by the sample, as the excitation light. This first optical system has the same configuration as that of the first optical system in the first embodiment, and thus its detailed description will be omitted.

A second optical system is provided between the sample cell 10 and the second photodetector 28b, to converge fluorescence from the sample, and lead the fluorescence to the second photodetector 28b serving as the fluorescence detection section. Further, a third optical system is provided between the sample cell 10 and the first photodetector 28a, to converge scattered light from the same position as a fluorescence measurement position of the sample set in the sample cell 10, and lead the scattered light to the first photodetector 28a serving as the excitation-light detection section.

The second optical system for leading the fluorescence to the second detector 28b comprises: a lens 20 for converting light from the sample cell into parallel light; a dichroic mirror 22 for reflecting a first group of light components having a wavelength band including a wavelength of the fluorescence, and transmitting therethrough a second group of light components having a wavelength band including a wavelength of the scatted light; an interference filter 24b for transmitting therethrough only a light component having the wavelength of the fluorescence among the first group of light components reflected by the dichroic mirror 22; and a lens 26b for converging the light component transmitted through the interference filter 24b, onto a light-receiving surface of the second photodetector 28b.

The third optical system for leading the scattered light to the first detector 28a comprises: the lens 20; the dichroic mirror 22; an interference filter 24a for transmitting therethrough only a light component having the wavelength of the scattered light (i.e., the excitation light) among the second group of light components transmitted through the dichroic mirror 22; and a lens 26a for converging the light component transmitted through the interference filter 24a, onto a light-receiving surface of the first photodetector 28a.

The reference numeral 30 indicates a fluorescence-intensity correction section operable to perform a calculation of dividing a signal indicative of an intensity of the fluorescence obtained from the second photodetector 28b by a signal indicative of an intensity of the scattered light obtained from the first photodetector 28a so as to correct the signal indicative of the intensity of the fluorescence, and output the corrected value as a measurement value. The intensity of the fluorescence is corrected by the intensity of the scattered light from the same position as the fluorescence measurement position in the sample cell 10. Thus, in the measurement value output from the fluorescence-intensity correction section 30, noise due to a fluctuation in intensity of the excitation light actually irradiating the sample is reduced as with the fluorescence-intensity correction section 19 in the first embodiment.

An operation of the fluorescence detection system according to the second embodiment will be described below.

When the sample set in the sample cell 10 is irradiated with the excitation light based on light from the light source lamp 2 passing through the first optical system, fluorescence and scattered light are generated from the sample. The light including fluorescence and scattered light is converted into parallel light through the lens 20, and the parallel light is led to the dichroic mirror 22. Then, the first group of light components is reflected by the dichroic mirror 22, and the light component transmitted through the interference filter 24b is converged by the lens 26b and led to the second photodetector 26b. Concurrently, the second group of light components is transmitted through the dichroic mirror 22, and the light component transmitted through the interference filter 24a is converged by the lens 26a and led to the first photodetector 26a. The first group of light components reflected by the dichroic mirror 22 includes the light component having the wavelength of the fluorescence, and the light component having the wavelength of the fluorescence is transmitted through the interference filter 24b, and led to the second photodetector 28b. The second group of light components transmitted through the dichroic mirror 22 includes the light component having the wavelength of the scattered light (i.e., the excitation light) without including the light component having the wavelength of the fluorescence, and the light component having the wavelength of the excitation light is transmitted through the interference filter 24a, and led to the first photodetector 28a. Thus, an intensity of the fluorescence generated from the sample is detected by the second photodetector 28b, and an intensity of the scattered light from the same position as the fluorescence measurement position in the sample cell 10 is detected by the first photodetector 28a. The fluorescence-intensity correction section 30 reads respective detection signals of the first and second photodetectors 28a, 28b, and outputs a calculated value obtained by dividing the signal indicative of the intensity of the fluorescence by the signal indicative of the intensity of the scattered light, as a measurement value.

Although the fluorescence detection system according to the second embodiment is designed to detect fluorescence and excitation light each included in a specific wavelength band, the present invention is not limited to this configuration. For example, a combination of a dichroic mirror, a filter and a converging lens may be added to the fluorescence detection optical system to detect fluorescence in a plurality of wavelength bands.

### Third Embodiment

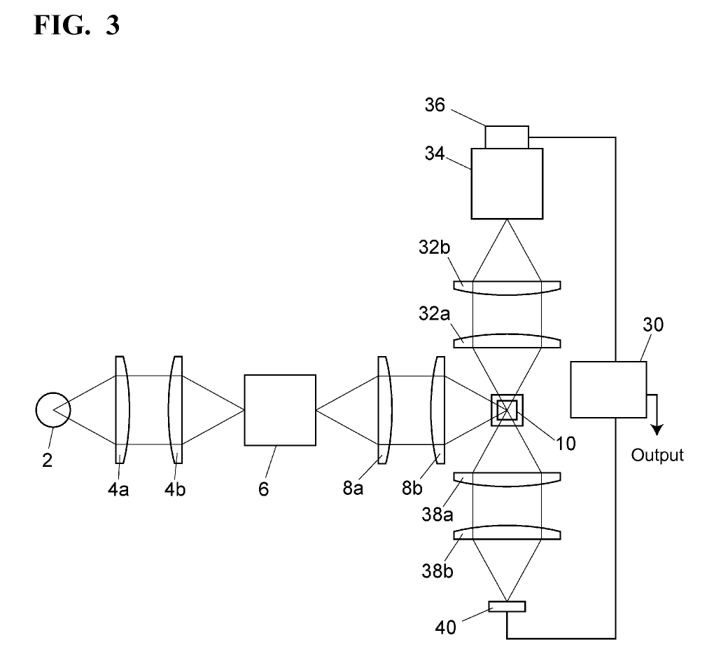

FIG. 3 is a block diagram schematically showing a configuration of a fluorescence detection system according to a third embodiment of the present invention.

The fluorescence detection system according to the third embodiment comprises a first photodetector 36, such as a photomultiplier, for detecting fluorescence generated from a sample set in a sample cell 10, and a second photodetector 40, such as a photomultiplier, for detecting scattered light from the same position as a fluorescence measurement position of the sample, wherein the second photodetector 40 is arranged on an opposite side of the first photodetector 36 with respect to the sample cell 10. A first optical system is provided between a light source lamp 2 and the sample cell 10. Further, a second optical system is provided between the sample cell 10 and the first photodetector 36, and a third optical system is provided between the sample cell 10 and the second photodetector 40. The first optical system has the same configuration as that of the first optical system in each of the first and second embodiments, and thus its detailed description will be omitted.

The second optical system comprises a pair of lenses 32a, 32b for converging light from the sample set in the sample cell 10, and a fluorescence-side wavelength selection means 34 for leading a light component having a wavelength of the fluorescence in the light converged by the lenses 32a, 32b, to the first photodetector 36, which is provided with a spectroscope for spectrally dispersing the converged light, or a filter for transmitting therethrough only a light component having a specific wavelength.

The third optical system comprises a pair of lenses 38a, 38b for converging light from the sample set in the sample cell 10, and leading the converged light to the second photodetector 40.

Respective detection signals of the first and second photodetectors 36, 40 are sent to a fluorescence-intensity correction section 30. The fluorescence-intensity correction section 30 is operable to perform a calculation of dividing a signal obtained from the first photodetector 36 by a signal obtained from the second photodetector 40, and output the calculated value as a measurement value.

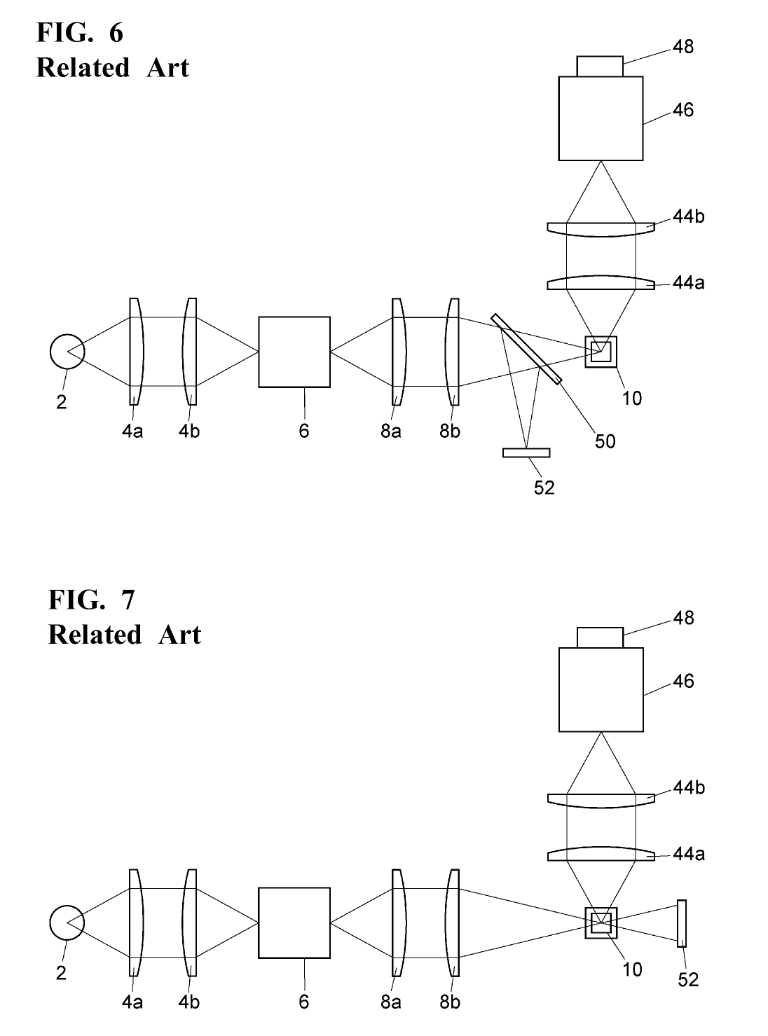

In the third embodiment, although light to be detected by the second photodetector 40 includes the fluorescence generated from the sample in addition to the scattered light from the same position as the fluorescence measurement position of the sample, the fluorescence generated from the sample is ignorable, because an intensity of the scattered light scattered from the sample is far greater than an intensity of the fluorescence. An error due to the fluorescence included in the light together with the scattered light is far smaller than an error due to a difference between an intensity of the excitation light irradiating the sample cell through the first optical system and an intensity of the excitation light actually contributing to generation of the fluorescence, in the conventional techniques as shown in FIGS. 6 and 7.

In the third optical system, a wavelength selection means may be additionally provided between the lens 38b and the second photodetector 40, to selectively lead a light component having a wavelength of the excitation light, to the second photodetector 40. In this case, light to be detected by the second photodetector 40 becomes free form the fluorescence generated from the sample, and therefore an error due to the fluorescence included in the light together with the scattered light can be eliminated.

### Fourth Embodiment

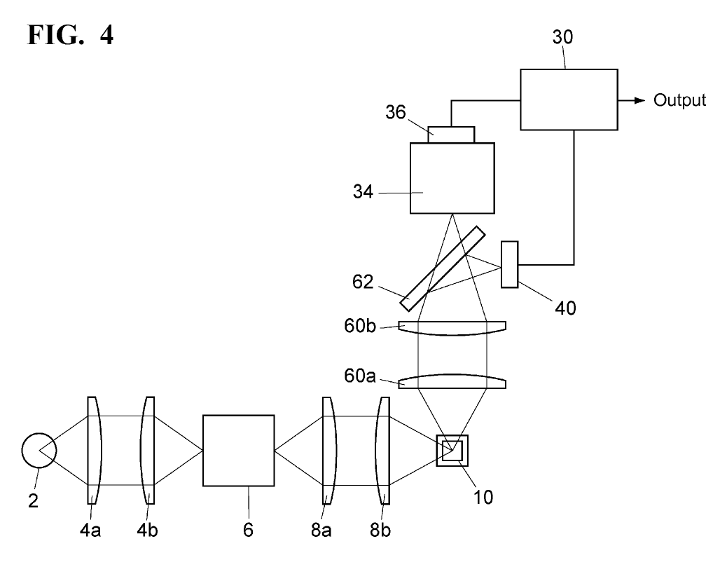

FIG. 4 is a block diagram schematically showing a configuration of a fluorescence detection system according to a fourth embodiment of the present invention.

In the fluorescence detection system according to the fourth embodiment, a first optical system is provided between a light source lamp 2 and a sample cell 10, and a second optical system and a third optical system are provided between the sample cell 10 and a first photodetector 36 and between the sample cell 10 and a second photodetector 40, respectively. The first optical system has the same configuration as that of the first optical system in each of the first to third embodiments, and thus its detailed description will be omitted.

The second optical system comprises: a pair of lenses 60a, 60b for converging light from a sample set in the sample cell 10, a beam-splitting means 62, such as beam splitter, for splitting the light converged by the lenses 60a, 60b into two light beams directed toward the first photodetector 36 and the second photodetector 40, respectively, and a fluorescence-side wavelength selection means 34 for selecting a light component having a wavelength of fluorescence in the light beam transmitted through the beam-splitting means 62, and leading the selected light beam to the first photodetector 36.

The third optical system comprises the lenses 60a, 60b, and the beam-splitting means 62.

In the above fluorescence detection system, a part of light beam converged by the lenses 60a, 60b after being emitted from the sample cell 10 is reflected by the beam-splitting means 62, and led to and detected by the second photodetector 40. Concurrently, the remaining light beam transmitted through the beam-splitting means 62 is led to the fluorescence-side wavelength selection means 34 to select a light component having a wavelength of the fluorescence, from the transmitted light beam. The selected light component is led to and detected by the first photodetector 36.

Although light to be detected by the second photodetector 40 includes fluorescence generated from the sample in addition to scattered light from the same position as a fluorescence measurement position in the sample cell 10, the fluorescence generated from the sample is ignorable, because an intensity of the scattered light scattered from the sample is far greater than an intensity of the fluorescence, in high-sensitive analysis. An error due to the fluorescence included in the light together with the scattered light is far smaller than an error due to a difference between an intensity of excitation light irradiating the sample cell through the first optical system and an intensity of the excitation light actually contributing to generation of the fluorescence, in the conventional fluorescence detectors as shown in FIGS. 6 and 7.

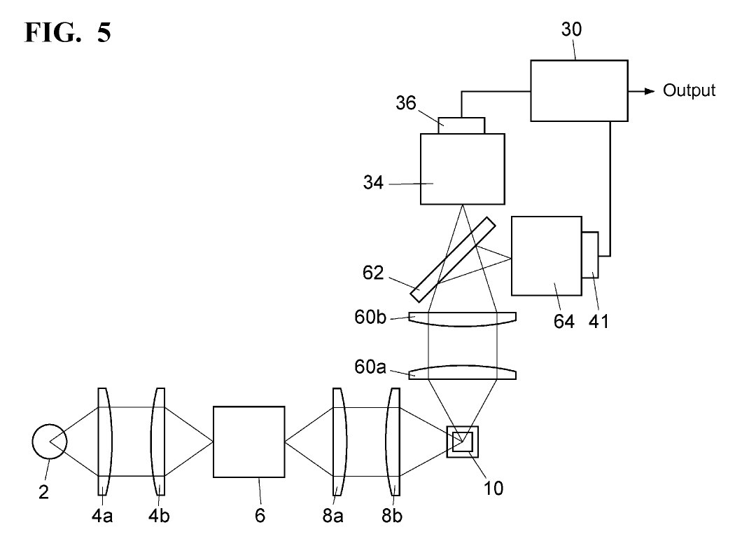

As shown in FIG. 5, in order to provide enhanced accuracy in correction by a fluorescence-intensity correction section 30, an excitation-side wavelength selection means 64 may be inserted between the beam-splitting means 62 and a second photodetector 41, such as a photomultiplier or a photodiode, to select a light component having a wavelength of the scattered light corresponding to an excitation light, and lead the selected light component to the second photodetector 41. In this case, the second photodetector 41 can detect the scattered light in light free form the fluorescence, and therefore an error due to the fluorescence included in the light together with the scattered light can be eliminated.

Although the fluorescence detection system according to each of the first to fourth embodiments employs a lens as an optical element for converging light, the present invention is not limited thereto, but any other suitable optical element, such as a concave mirror or a nonspherical mirror, may be used.

What is claimed is:

1. A fluorescence detection system comprising:
a light source;
a sample cell;
a first optical system for irradiating a sample set in said sample cell, with excitation light based on light from said light source;
a fluorescence detection section for detecting fluorescence generated from said sample;
a second optical system for selectively leading the fluorescence from said sample to said fluorescence detection section;
an excitation-light detection section for detecting scattered light from said sample cell;
a third optical system for leading scattered light from a same position as a fluorescence measurement position of said sample set in said sample cell, to said excitation-light detection section; and
a fluorescence-intensity correction section for correcting a detection value of said fluorescence detection section by a detection value of said excitation-light detection section.

2. The fluorescence detection system as defined in claim 1, wherein:
said second optical system and said third optical system share a common spectral dispersion element; and
said fluorescence detection section and said excitation-light detection section are formed as an array-type photodetector having an array of light-receiving elements arranged in a spectral dispersion direction of said spectral dispersion element, wherein said fluorescence detection section is made up of at least one of said light-receiving elements disposed at a position capable of receiving a light component having a wavelength of the fluorescence among light components spectrally dispersed by said spectral dispersion element, and said excitation-light detection section is made up of at least one of the remaining light-receiving elements disposed at a position capable of receiving a light component having a wavelength of the excitation light among the light components spectrally dispersed by said spectral dispersion element.

3. The fluorescence detection system as defined in claim 1, wherein said second optical system and said third optical system share a common dichroic mirror configured to reflect one of a first group of light components having a wavelength band including a wavelength of the fluorescence and a second group of light components having a wavelength band including a wavelength of the excitation light, and transmit the other of said first and second groups therethrough, in such a manner as to allow said first group and said second group in light which have undergone said dichroic mirror, to be detected by said fluorescence detection section and said excitation-light detection section, respectively.

4. The fluorescence detection system as defined in claim 1, wherein said second optical system and said third optical system are axisymmetrically arranged with respect to a symmetry axis defined by an optical axis of the excitation light entering from said first optical system into said sample cell.

5. The fluorescence detection system as defined in claim 4, wherein said third optical system includes a spectral dispersion element operable to select a light component having a wavelength of the excitation light, and lead said selected light component to said excitation-light detection section.

6. The fluorescence detection system as defined in claim 1, wherein said second optical system and said third optical system share common beam-splitting means operable to reflect a part of light beam from said sample cell, and transmit the remainder therethrough, in such a manner as to allow the two light beams split by said beam-splitting means to be detected by said excitation-light detection section and said fluorescence detection section, respectively.

7. The fluorescence detection system as defined in claim 6, wherein said third optical system includes a spectral dispersion element operable to select a light component having a wavelength of the excitation light, and lead said selected light component to said excitation-light detection section.
